(19) United States
(12) Patent Application Publication
(10) Pub. No.: US 2023/0195855 A1
(43) Pub. Date: Jun. 22, 2023

(54) Location-Specific Non-Fungible Tokens

(71) Applicant: Disney Enterprises, Inc., Burbank, CA (US)

(72) Inventors: Dionysius Mavromatis, Kirkland, WA (US); Christiaan A. Cokas, Chester, CT (US); Adam D. Eivy, Vashon, WA (US); Samuel J. Reisner, Farmington, CT (US); Katharine S. Navarre, Los Angeles, CA (US)

(21) Appl. No.: 18/079,230

(22) Filed: Dec. 12, 2022

Related U.S. Application Data
(60) Provisional application No. 63/290,503, filed on Dec. 16, 2021.

(51) Int. Cl. G06F 21/10; G06V 20/40; G06T 19/00

(52) U.S. Cl. CPC G06F 21/10; G06V 20/44; G06T 19/006

(57) ABSTRACT

According to one exemplary implementation, a system includes a hardware processor and a system memory storing a software code. The hardware processor is configured to execute the software code to receive, from a user device, a request for a non-fungible token (NFT) based on the presence of a user of the user device in a venue, receive sensor data identifying a location of the user device, and obtain camera data from the venue, the camera data depicting at least one of the user of the user device or a field of view of the user relative to the venue. The hardware processor is further configured to execute the software code to mint the NFT, using the sensor data and the camera data, wherein the NFT depicts at least one of a portion of an object situated within the venue or an event occurring at the venue.

### RELATED APPLICATIONS

The present application claims the benefit of and priority to a pending U.S. Provisional Patent Application Ser. No. 63/290,503 filed on Dec. 16, 2021, and titled “Location-Specific Non-Fungible Tokens,” which is hereby incorporated fully by reference into the present application.

### BACKGROUND

Some venues, such as sports stadiums, theaters, concert halls, and theme parks, for example, can provide users of those venues and observers of the events that take place there with enjoyable or even momentous experiences. Moreover, those venues and events may be even more significant when they are enjoyed as part of a group experience including family, friends, or both. A conventional approach to memorializing such significant experiences includes manually taking pictures or video, for example. However, those actions may be undesirably distracting when performed as the experience is unfolding, and often undesirably fail to depict the individual taking the pictures or video. Thus, there is a need in the art for systems and methods for providing location-specific non-fungible tokens (NFT) that capture and memorialize a user's experience in a way that is specific to the perspective or preferences of the user without causing the user to lose immersion in the experience itself.

### BRIEF DESCRIPTION OF THE DRAWINGS

FIG. 1 shows a system for providing location-specific non-fungible tokens (NFTs), according to one exemplary implementation;

FIG. 2 shows an exemplary user device of a user of the system shown in FIG. 1, according to one implementation;

FIG. 3 shows a top-down view of a venue in the form of a sports arena, according to one implementation;

FIG. 4 shows a frontal view of an object serving as the subject of a location-specific NFT, according to one implementation;

FIG. 5A shows a flowchart describing an exemplary method for providing location-specific NFTs, according to one implementation; and

FIG. 5B shows additional actions for extending the method described in FIG. 5A, according to one implementation.

### DETAILED DESCRIPTION

The following description ns specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The technology known as a non-fungible token (NFT) confers ownership to a digital asset, such as a file containing a photo or other image, video, audio, or any other desirable digital representation of a real or virtual object or event. An NFT includes a unit of data stored on a secure digital ledger, such as a blockchain for example, that certifies a digital asset to be unique and therefore non-fungible. An NFT can include a digital asset that is typically stored in and accessible via the cloud, and authenticate the ownership of that digital asset by an individual or entity. However, in contrast to traditional ownership rights, ownership of an NFT does not prevent others from accessing, or even copying, the NFT certified digital asset. That is to say, an NFT confers ownership of a digital asset that is separate from copyright.

The present application discloses systems and methods providing location-specific NFTs. As stated above, some physical venues, such as sports stadiums, theaters, concert halls, and theme parks, for example, can provide users of those locations and observers of the events that take place at those locations with enjoyable or even momentous experiences. It may be desirable to memorialize those experiences through ownership of a location-specific NFT tied to a specific location or to a specific event or action that took place at such a location. For example, a person attending a football game may wish to obtain a location-specific NFT depicting the winning touchdown as time runs out, from the perspective that person had of the game winning play (e.g., the person's seat in the football stadium), a football team's bench, a referee's position, etc.; a location-specific NFT depicting the presence of that person in the football stadium as the play unfolds; or even a location-specific NFT depicting that person as a participant in the game winning play, rather than merely an observer of it.

Alternatively, or in addition, a visitor to a monument or other significant physical object may wish to obtain a location-specific NFT depicting all or a portion of the object, and tied to the specific physical location of that object. For instance, a tourist viewing Michelangelo's sculpture of Moses in Rome may wish to obtain a location-specific NFT showing the sculpture or a portion of the sculpture, such as only the head of Moses, for example, and tied to the volume in space bounding the sculpture or merely its head. Moreover, the present approach to providing location-specific NFTs may advantageously be implemented as automated systems and methods.

As used in the present application, the terms “automation,” “automated,” and “automating” refer to systems and processes that do not require the participation of a human system operator. Although, in some implementations, a system operator or administrator may review or even adjust the performance of the automated systems and according to the automated methods described herein, that human involvement is optional. Thus, the methods described in the present application may be performed under the control of hardware processing components of the disclosed automated systems.

It is noted that, as defined in the present application, the term “location-specific NFT” may refer to any location-specific digital asset having its ownership certified by NFT credentials (e.g., public and private keys). Location-specific NFTs may include digital files containing an image or images, video without audio, audio without video, or audio-video (AV) content, such as all or part of television (TV) episodes, movies, sporting events, or video games, to name a few examples. In addition, or alternatively, in some implementations, a location-specific NFT may include a digital representation of persons, fictional characters, locations, objects, and identifiers such as brands and logos, for example, which populate a virtual reality (VR), augmented reality (AR), or mixed reality (MR) environment. Such digital representations may depict virtual worlds that can be experienced by any number of users synchronously and persistently, while providing continuity of data such as personal identity, user history, entitlements, possessions, payments, and the like. Moreover, in some implementations, a location-specific NFT may include a hybrid of traditional audio-video and fully immersive VR/AR/MR experiences, such as interactive video.

It is further noted that the term “digital wallet” may refer to any secure software application assigned to an owner of an NFT that stores the NFT credentials certifying ownership of a location-specific NFT or other NFT, and enables the location-specific owner to reassign, i.e., sell or otherwise transfer ownership of the location-specific NFT to another person or entity. It is also noted that the relationship between a location-specific NFT and a digital wallet is many-to-one rather than one-to-one. That is to say, in some implementations, the same digital wallet may store NFT credentials for each of multiple location-specific NFTs. However, the NFT credentials of a location-specific NFT are uniquely present in only one digital wallet at a time.

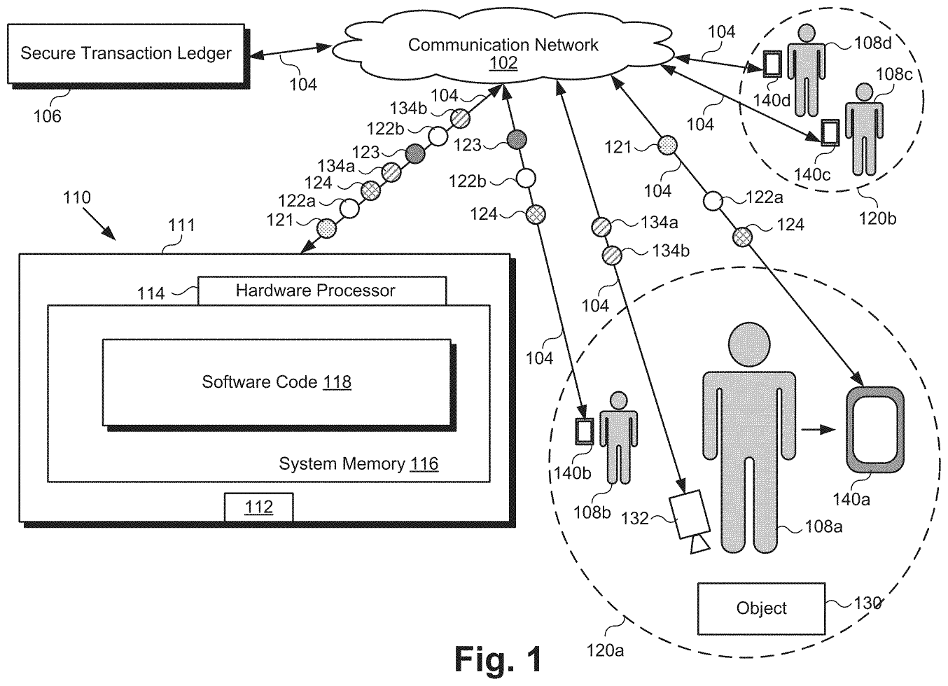

FIG. 1 shows system 110 configured to provide location-specific NFTs, according to one exemplary implementation. As shown in FIG. 1, system 110 includes computing platform 111 having transceiver 112, hardware processor 114, and system memory 116 implemented as a computer-readable non-transitory storage medium. According to the present exemplary implementation, system memory 116 stores software code 118. In addition, FIG. 1 shows NFT collectors 108a and 108b present at venue 120a including object 130, NFT collectors 108c and 108d present at venue 120b, user devices 140a, 140b, to 140c, and 140d utilized by respective NFT collectors 108a, 108b, 108c, and 108d, one or more cameras 132 (hereinafter “camera(s) 132”), secure transaction ledger 106, communication network 102 and network communication links 104 communicatively coupling system 110 to secure transaction ledger 106, camera(s) 132, and user devices 140a, 140b, 140c, and 140d.

Also shown in FIG. 1 are request 121, first sensor data 122a, second sensor data 122b, affinity data 123, first camera data 134a, and location-specific NFT 124 distributed to user devices 140a and 140b of respective NFT collectors 108a and 108b, via communication network 102 and network communication links 104. It is noted that affinity data 123 may include any data enabling a particular user, such as NFT collector 108b for example, to associate himself/herself with another user, such as NFT collector 108a. Examples of affinity data 123 received from NFT collector 108b and identifying NFT collector 108a may include a phone number, email address, or a social media identifier such as a social media username of NFT collector 108a, to name a few.

Camera(s) 132 may include one or more two-dimensional (2D) still image or video cameras, one or more volumetric cameras such as three dimensional (3D) cameras, or one or more cameras configured to capture panoramic images, such as 360″ cameras for example. First camera data 134a may include a media asset including image data captured by camera(s) 132, time stamps of that image data, and telemetry data for camera(s) 132, such as the location, focal length, and zoom factor of each of camera(s) 132, their respective spatial orientations, in terms of polar and azimuthal angles, for example, and any other location-specific data or metadata generated by camera(s) 132.

Furthermore, although not depicted in FIG. 1, one or more cameras corresponding to camera(s) 132 may be situated in each of venues 120a and 120b. It is noted that, in various implementations, venues 120a and 120b may be real-world physical venues or virtual venues. In implementations in which one or both of venues 120a and 120b is a real-world physical venue, such a venue may be a sporting venue such as a stadium or arena, a recreation or hotel/resort property, a theme park, a concert hall, cinema, theater or other entertainment venue, a hotel, a cruise ship, or the immediate vicinity, e.g., within ten feet or any other predetermined distance, of a physical object or coordinate (e.g., latitude, longitude, and altitude). In implementations in which one or both of venues 120a and 120b is a virtual venue, such a venue may be an interactive video environment, which, in some implementations, may be configured to provide one or more of a VR, AR, or MR experience to NFT collectors 108a, 108b, 108c, and 108d. For example, venue 120a or 120b, or both, may be or include a digital representation of a location including persons, fictional characters, objects, and identifiers such as brands and logos, for example, which populate a VR, AR, or MR environment. Such a digital representation may depict a virtual world that can be experienced by any number of users synchronously and persistently, while providing continuity of data such as personal identity, user history, entitlements, possessions, payments, and the like.

With respect to the representation of system 110 shown in FIG. 1, it is noted that although software code 118 is depicted as being stored in system memory 116 for conceptual clarity, more generally, system memory 116 may take the form of any computer-readable non-transitory storage medium. The expression “computer-readable non-transitory storage medium,” as used in the present application, refers to any medium, excluding a carrier wave or other transitory signal that provides instructions to hardware processor of a computing platform, such as hardware processor 114 of computing platform 111. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

It is further noted that although FIG. 1 depicts software code 118 as being entirely located in a single instance of system memory 116, that representation is also merely provided as an aid to conceptual clarity. More generally, system 110 may include one or more computing platforms, such as computer servers for example, which may be co-located, or may form an interactively linked but distributed system, such as a cloud-based system, for instance. As a result, hardware processor 114 and system memory 116 may correspond to distributed processor and memory resources of system 110. Thus, it is to be understood that various software modules of software code 118 may be stored remotely from one another within the distributed memory resources of system 110.

Hardware processor 114 may include multiple hardware processing units, such as one or more central processing units, one or more graphics processing units, one or more tensor processing units, one or more field-programmable gate arrays (FPGAs), and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 111, as well as a Control Unit (CU) for retrieving programs, such as software code 118, from system memory 116, while a GPU may be implemented to reduce the processing overhead of the CPU by performing computationally intensive graphics or other processing tasks. A TPU is an application-specific integrated circuit (ASIC) configured specifically for artificial intelligence (AI) applications such as machine learning modeling.

In some implementations, computing platform 111 may correspond to one or more web servers, accessible over a packet-switched network such as the Internet, for example. Alternatively, computing platform 111 may correspond to one or more computer servers supporting a private wide area network (WAN), local area network (LAN), or included in another type of limited distribution or private network. However, in some implementations, system 110 may be implemented virtually, such as in a data center. For example, in some implementations, system 110 may be implemented in software, or as virtual machines. Moreover, in some implementations, communication network 102 may be a high-speed network suitable for high performance computing (HPC), for example a 10 GigE network or an Infiniband network.

Transceiver 112 of system 110 may be implemented as a wireless communication unit configured for use with one or more of a variety of wireless communication protocols. For example, transceiver 112 may be implemented as a fourth generation (4G) wireless transceiver, or as a 5G wireless transceiver. In addition, or alternatively, transceiver 112 may be configured for communications using one or more of Wireless Fidelity (Wi-Fi), Worldwide Interoperability for Microwave Access (WiMAX), Bluetooth, Bluetooth low energy, ZigBee, radio-frequency identification (RFID), near-field communication (NFC), and 60 GHz wireless communications methods.

System 110 may be configured to create or “mint” NFTs, to mint and warehouse NFTs, or to distribute or warehouse NFTs minted by others. Secure transaction ledger 106 may take the form of a public or private secure transaction ledger. Examples of such secure transaction ledgers may include Blockchain, Hashgraph, Directed Acyclic Graph (DAG), and Holochain ledgers, to name a few. In use cases in which secure transaction ledger 106 is a blockchain ledger, it may be advantageous or desirable to implement secure transaction ledger 106 to utilize a consensus mechanism having a proof-of-stake (PoS) protocol, rather than the more energy intensive proof-of-work (PoW) protocol. Although secure transaction ledger 106 is shown to be remote from system 110 in FIG. 1, such as a cloud-based or distributed secure transaction ledger, that implementation is merely exemplary. In other implementations, secure transaction ledger 106 may be stored in system memory 116 and may be controlled by system 110.

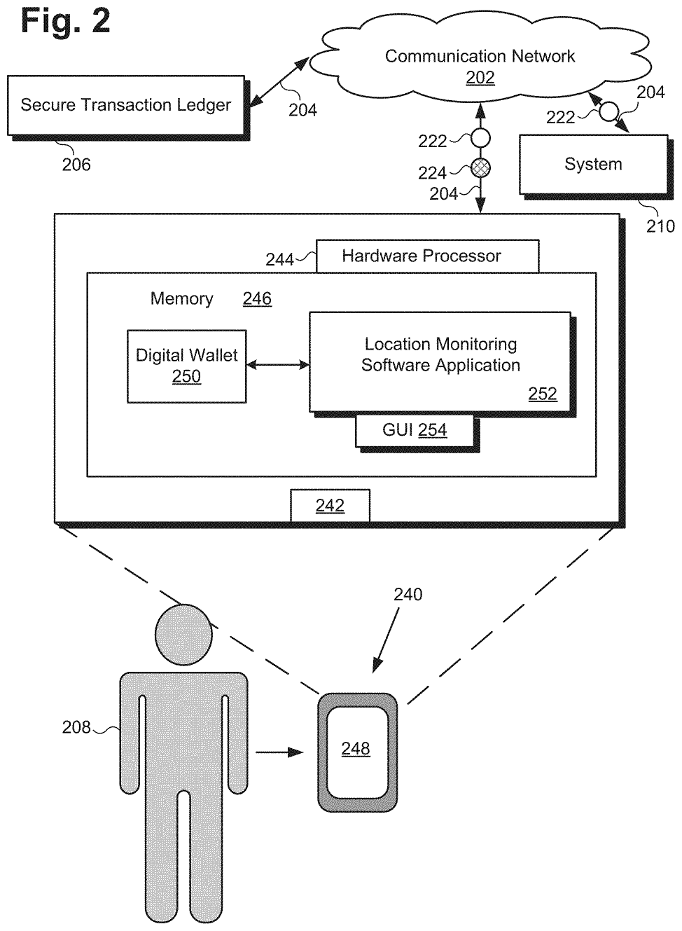

FIG. 2 shows user device 240 of NFT collector 208, according to one implementation. As shown in FIG. 2, user device 240 includes transceiver 242, hardware processor 244, display 248, and memory 246 implemented as a computer-readable non-transitory storage medium storing digital wallet 250 and location monitoring software application 252 providing GUI 254. Also shown in FIG. 2 are system 210, communication network 202, network communication links 204, secure transaction ledger 206, sensor data 222, and location-specific NFT 224.

Although user device 240 is shown as a smartphone in FIG. 1 that representation is provided merely as an example. More generally, user device 240 may be any suitable mobile or stationary computing device or system that implements data processing capabilities sufficient to provide GUI 254, support connections to communication network 202, and implement the functionality ascribed to user device 240 herein. For example, in other implementations, user device 240 may take the form of a desktop computer, laptop computer, tablet computer, smart TV, or a smart wearable device, such as a smartwatch for example, or a VR or AR device.

Transceiver 242 may be implemented as a wireless communication unit configured for use with one or more of a variety of wireless communication protocols. For example, transceiver 242 may be implemented as a 4G wireless transceiver, or as a 5G wireless transceiver. In addition, or alternatively, transceiver 242 may be configured for communications using one or more of Wi-Fi, WiMAX, Bluetooth, Bluetooth low energy, ZigBee, RFID, NFC, and 60 GHz wireless communications methods.

With respect to display 248 of user device 240, display 248 may be physically integrated with user device 240 or may be communicatively coupled to but physically separate from user device 240. For example, where user device 240 is implemented as a smartphone, laptop computer, or tablet computer, display 248 will typically be integrated with user device 240. By contrast, where user device 240 is implemented as a desktop computer, display 248 may take the form of a monitor separate from user device 240 in the form of a computer e Furthermore, display 248 of user device 240 may be implemented as a liquid crystal display (LCD), a light-emitting diode (LED) display, an organic light-emitting diode (OLED) display, a quantum dot (QD) display, or any other suitable display screen that performs a physical transformation of signals to light.

Location monitoring software application 252 may be configured to initiate a secure and authorized communication session in order to use transceiver 242 to receive or transmit sensor data 222 including the latitude, longitude, altitude or any combination thereof at which user device 240 is located, or any other suitable geolocation or spatial sensor data such as Global Positioning System (GPS) data or data in the form of one or more of Near-Field Communication (NFC) data, Beacon data, Bluetooth or Bluetooth LE data, or radio-frequency identification (RFID) data. Alternatively, or in addition, in some implementations, Wi-Fi, cellular network locations, IP addresses or any combination of those features may be used to determine the location of user device 240. Moreover, in some use cases sensor data 222 may be provided by user device 240 when user device 240 is utilized by a user, such as NFT collector 208, to voluntarily check in with system 210.

As another alternative, a particular location, such as a seat in a stadium or other entertainment venue, or the location of object 130 in FIG. 1, may display a barcode or Quick Response (QR) code that may be fixed, or that may cycle every few seconds, or over any other predetermined time period. In those implementations, NFT collector 208 could use user device 240 to scan such a barcode of QR code and transmit it to system 210, thereby identifying the location of NFT collector 208 at the time of transmission of the code.

As yet another alternative, or in addition, NFT collector 208 may utilize an authenticator application, which may be supported by user device 240, or may be shown on a display present at a particular location. The authenticator application may provide a pin number that cycles every few seconds, or over any other predetermined time period. In those implementations, NFT collector 208 could enter that pin number into user device 240 for transmission to system 210.

According to the exemplary implementation shown in FIG. 2, digital wallet 250 can store location-specific NFT 224 on user device 240. However, in other implementations, digital wallet 250 may not be resident on user device 240, but may be a virtual wallet remote from user device 240, such as a cloud-based virtual wallet accessible to user device 240 via communication network 202 and network communication links 204. In yet other implementations, digital wallet 250 may be a hardware cryptocurrency wallet, such as a Ledger Nano S® device or the like.

System 210, communication network 202, network communication links 204, sensor data 222, location-specific NFT 224, and secure transaction ledger 206 correspond. respectively in general to system 110, communication network 102, network communication links 104, either or both of first sensor data 122a and second sensor data 122b, location-specific NFT 124, and secure transaction ledger 106, in FIG. 1. Thus, system 210, communication network 202, network communication links 204, sensor data 222, location-specific NFT 224, and secure transaction ledger 206 may share any of the characteristics attributed to respective system 110, communication network 102, network communication links 104, first sensor data 122a and second sensor data 122b, location-specific NFT 124, and secure transaction ledger 106 by the present disclosure, and vice versa.

Moreover, NFT collector 208, in FIG. 2, corresponds in general to any one or all of NFT collectors 108a, 108b, 108c, and 108d, in FIG. 1, while user device 240 corresponds in general to any or all of user devices 140a, 140b, 140c, and 140d, Thus, NFT collectors 108a, 108b, 108c, and 108d may share any of the characteristics attributed to NFT collector 208 by the present disclosure, and vice versa, while user devices 140a, 140h, 140c, and 140d may share any of the characteristics attributed to user device 240, and vice versa. That is to say, although not shown in FIG. 1, each of user devices 140a, 140b, 140c, and 140d may to include features corresponding respectively to transceiver 242, hardware processor 244, and memory 246 storing digital wallet 250, location monitoring software application 252 providing GUI 254, and display 248.

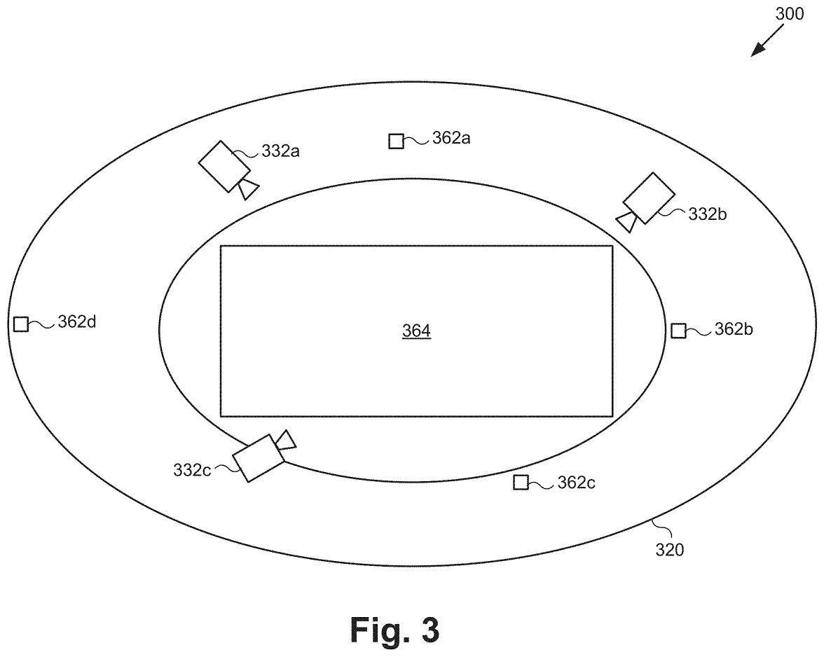

FIG. 3 shows top-down view 300 of venue 320 in the form of an arena or stadium including event area 364 (e.g., field, pitch, ring, court, or stage), cameras 332a, 332b, and 332c (hereinafter “cameras 332a-332c”), and spectator seats 362a, 362b, 362c, and 362d (hereinafter “spectator seats 362a-362d”). Venue 320 and cameras 332a-332c correspond respectively in general to venues 120a/120b and camera(s) 132, in FIG. 1. Thus, venue 320 and cameras 332a-332c may share any of the characteristics attributed to venues 120a/120b and camera(s) 132 by the present application, and vice versa. For example, like camera(s) 132, each of cameras 332a-332c may generate and transmit first camera data 134a, in FIG. 1, to system 110. Moreover, like one or both of venues 120a and 120b, in some implementations venue 320 may be a virtual venue of an interactive video environment providing one or more of a VR, AR, or MR experience.

It is noted that although FIG. 3 shows three exemplary cameras 332a-332c, more generally, cameras 332a-332c may correspond to more than three cameras, such as dozens of cameras, for example. It is further noted that although FIG. 3 shows four exemplary spectator seats 362a-362d, more generally, spectator seats 362a-362d may correspond to more than four spectator seats, such as tens, hundreds, thousands or tens of thousands of spectator seats, for example.

Referring to FIGS. 1 and 3 in combination, according to the exemplary implementation shown in FIG. 3, hardware processor 114 of system 110 may execute software code 118 to receive sensor data, such as first sensor data 122a for example, from a to user device of a user occupying one of spectator seats 362a-362d (e.g., spectator seat 362a), receive first camera data 134a from cameras 332a-332c, may generate a location-specific NFT depicting an event occurring during an activity-performed in venue 120a/120b/320 (e.g., a scoring play, from the perspective of the user occupying spectator seat 362a), and may mint a location-specific NFT for that user. Moreover, in some implementations such a location-specific NFT may take the form of an altered computer generated (CG) representation of a sports play or event that includes the user as an identifiable observer or participant. By way of example, in some implementations, the sports play depicted by the location-specific NFT may be a scoring play, and the location-specific NFT may further depict the user as executing the scoring play.

It is noted that, in implementations in which the location-specific NFT depicts a particular sports play, that location-specific NFT is event-specific, time-specific, or both in addition to being location-specific. Moreover, in some implementations, a location-specific NFT may be user device specific. For instance, referring to FIG. 2, sensor data 222 may include a device identifier of user device 240 enabling system 210 to identify user device 240 as a brand “X” model “Y” device. In some implementations, the location-specific NFT minted for the user of user device 240 may depict branding or other insignia of the user device manufacturer. In addition, or alternatively, a location-specific NFT may be minted to include advertising targeted to the user present at a particular location or attending an event to further personalize the location-specific NFT. For example, such targeted advertising may promote a corporate sponsor of the event attended by the user, may be based on a demographic profile of the user, may be based on known or inferred preferences of the user, or any combination thereof.

It is noted that in other implementations, the features described by reference to FIG. 3 may be quite different from the features actually depicted. For example, rather than a sports arena, venue 120a/120b/320 may take the form of a theater or concert hall. As a specific example, venue 120a/120b/320 may be a theater hosting an awards ceremony for actors. In that example, spectator seats 362a-362d may be seats occupied by actors who are also members of the awards ceremony audience having been nominated for the acting award. In that use case, hardware processor 114 of system 110 may execute software code 118 to receive first camera data 134a from cameras 332a-332c, receive first sensor data 122a from user devices used or worn by each award nominee, and may mint a location-specific NFT depicting presentation of the award, from the perspective of the winning nominee. Moreover, in some such implementations, that location-specific NFT may take the form of an altered CG representation of the presentation of the award that includes the location-specific NFT owner as an identifiable observer, participant, or recipient of the award.

As yet other alternative implementations, the event occurring at venue 120a/120b/320 may be an entertainment event, such as theatrical production or musical performance, attended by a user. In those exemplary implementations, For example, a location-specific NFT may take the form of an altered CG representation of the entertainment that includes the user as an identifiable observer or participant. For instance, in some implementations the location-specific NFT may depict the user as participating in the entertainment in a lead role or supporting role.

It is also noted that the location-specific NFT for the location-specific NFT may include a data payload including the camera telemetry data used to mint the location-specific to NFT, as well as identifying the location-specific NFT itself. One advantage of such an approach is that it facilitates future generation of variant location-specific NFTs.

The expression “variant location-specific NFT” refers to a location-specific NFT having one or more modified or enhanced features relative to the original location-specific NFT to which the variant asset is compared. As a specific example, where a location-specific NFT owned by NFT collector 208, in FIG. 2, corresponds to an attraction or live event, a variant of that location-specific NFT may depict characters in that attraction or event having one or more of different costuming, different coloring, possessing different accessories, framed against a different background environment, wearing different expressions, or stamped with a limited release number, date, time, or location identifier, to name a few examples. Alternatively, or in addition, in some implementations, a location-specific NFT or its variant may include metadata enabling its recipient, e.g., NFT collector 208, to enjoy an VR, AR, or MR experience, thereby bridging the real-world with a virtual one, or even expanding the real-world into omniverse realms.

It is noted that variant location-specific NFTs are typically independent of the original location-specific NFTs upon which they are based. As a result, variant location-specific NFTs can usually be transferred independently of those original location-specific NFTs. Nevertheless, in some implementations, the original location-specific NFT may be “burned”, i.e., destroyed, and the variant location-specific NFT may be reminted as a descendent upgrade of the original. For example, where an NFT collector owns a location-specific NFT depicting a portion of a physical object having a permanent location, the original location-specific NFT may be burned and the NFT collector may receive a newly minted variant location-specific NFT depicting a larger portion or a more desirable portion of that object Once location specific NFT 124 in FIG. 1, or a variant location-specific NFT, is minted and awarded or otherwise assigned, hardware processor 114 of system 110 may execute software code 118 to record the details of that minting and NFT ownership on secure transaction ledger 106/206, which may serve as the sole repository of that activity.

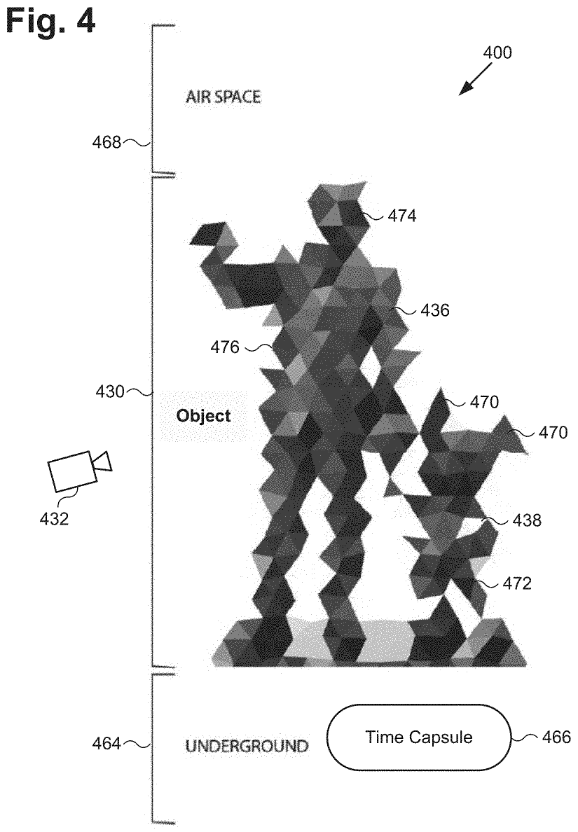

FIG. 4 shows frontal view 400 of object 430 serving as the subject of a location-specific NFT, according to one implementation. According to the exemplary implementation shown in FIG. 4, object 430 is shown as a geometric representation of a humanoid figure 436, having head 474 and torso 476, and joined by companion animal or character 438 having ears 470 and leg 472. It is noted that, in various implementations, object 430 may be a 2D or 3D object, a hologram, and in some implementations may incorporate additional features such as one or more of aromas, sounds, and gestures or other movements. In addition to object 430, FIG. 4 shows underground 464, which optionally includes time capsule 466 located beneath object 430, as well as airspace 468 above object 430. Also shown in FIG. 4 are one or more cameras 432 (hereinafter “camera(s) 432”).

Object 430 corresponds in general o object 130, in FIG. 1, and those corresponding features may share any of the characteristics attributed to either corresponding feature by the present application. In addition, camera(s) 432, in FIG. 4, correspond to camera(s) 132, in FIG. 1. Thus, camera(s) 432 may share any of the characteristics attributed to corresponding camera(s) 132 by the present disclosure, and vice versa.

Referring to FIGS. 1 and 4 in combination, according to the exemplary implementation shown in FIG. 4, hardware processor 114 of system 110 may execute software code 118 to receive first sensor data 122a from a user device of an observer viewing object 130/430 or from location sensors local to object 130/430, receive first camera data 134a from camera(s) 432, may generate a location-specific NFT depicting all or a portion of object 130/430, some or all of the contents of time capsule 466 (if present), or any combination thereof, from the perspective of the observer, and may mint a location-specific NFT for that location-specific NFT conferring ownership of the location-specific NFT to that observer. For example, such a location-specific NFT may take the form of an altered CG representation of object 130/430 that includes the location-specific NFT owner as an identifiable observer of object 130/430 or appearing to interact with object 130/430.

Object 430 may be assigned a geolocation footprint, such as a volumetric region bounding object 430 and defined by a predetermined radius and the height of object 430, both of which may be determined based on a digital scale model of object 430. The location-specific NFT available for purchase based on object 430 could be one of a limited integer number “N” of identical location-specific NFTs, which could also serve as the basis for variant location-specific NFTs, such as special editions, holiday editions, anniversary editions, special event commemoration editions, and the like.

In use cases in which object 430 has a special status within a venue, such as a statue or sculpture situated in a park named for or otherwise honoring the figure or figures depicted by object 430, having ownership of a location-specific NFT for object 430 or a portion of object 430 can provide a location-specific NFT collector with a special status within the venue. For example, that special status which may unlock VR, AR, or MR experiences enabled using location monitoring software application 252, in FIG. 2, or can provide VIP experiences or reduced wait times for attractions within the venue. In some implementations, the benefits conferred to the location-specific NFT collector can be extended to other users of the venue to enhance and foster connections among visitors to the venue. In addition, or alternatively, in some implementations a location-specific NFT collector can combine their location-specific NFT with other NFTs, whether location-specific or not, and either owned by the location-specific NFT collector or discovered by that collector through interactions with other venue visitors, to unlock other venue based enhancements, such as a special event presentation displayed within the venue using digital signage or some fort of pyrotechnics, for example.

As noted above by reference to FIG. 3, in some implementations a location-specific NFT may be event-specific, time-specific, or both, in addition to being location-specific. In some implementations, in addition to GPS data, the proximity of a user or location-specific NFT collector to object 430 may be detected by system 110 via one or more of NFC data, Beacon data, Bluetooth or Bluetooth LE data, or radio-frequency identification (RFID) data.

In some use cases, a location-specific NFT may confer ownership of a portion of object 430, such as a specific surface area or object 430, rather than the entire object. In those use cases, the location-specific NFT may represent ownership of an otherwise unspecified portion of object 430, such as one percent of the surface area of object 430, or any other particular surface area portion, without identifying the location of that surface region on object 430. However, in some use cases, different portions of object 430 may be more or less desirable to location-specific NFT collectors. For example, a location-specific NFT conferring ownership of a portion of ear 470 of companion animal or character 438 may be more desirable, and therefore more costly, than a location-specific NFT conferring ownership of a portion of leg 472, while a location-specific NFT conferring ownership of a portion of head 474 of humanoid figure 436 may be more desirable and costly than a location-specific NFT conferring ownership of a portion of torso 476.

System 110/210 in FIGS. 1 and 2, may be configured to manage the various entitlements and orchestrate the rules and events available to the location-specific NFT collectors and other visitors to the venue including object 430. Such management and orchestration may include determining whether an enhancement is being used by a location-specific NFT collector or has been extended for a length of time to another venue visitor, identifying whether available entitlements are digital, physical, or whether both are available, delivering assets or integrating with other venue assets to enhance the location-specific NFT collector or visitor experience, and mediating trading or sale of location-specific NFTs thereby adding value to the location-specific NFT, to name a few examples.

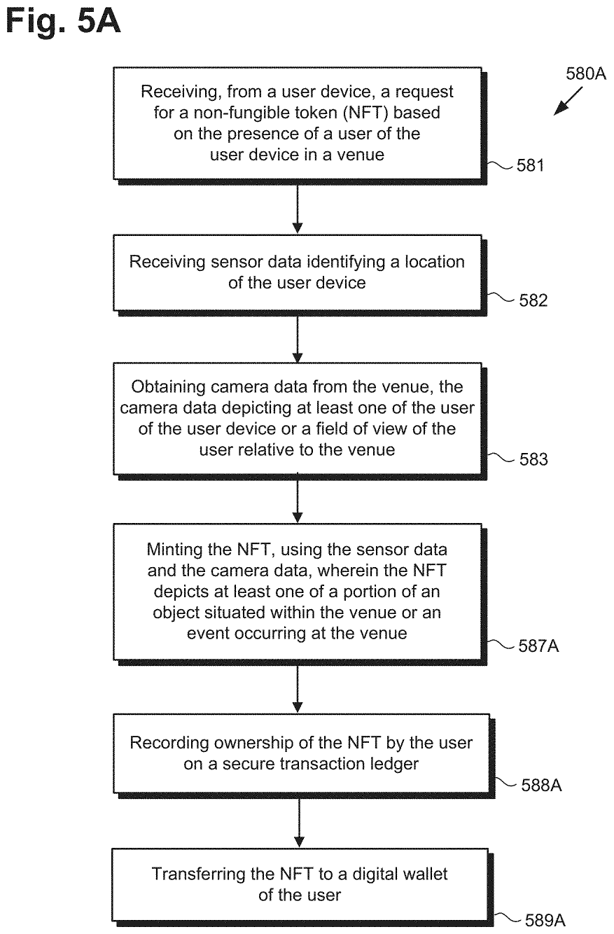

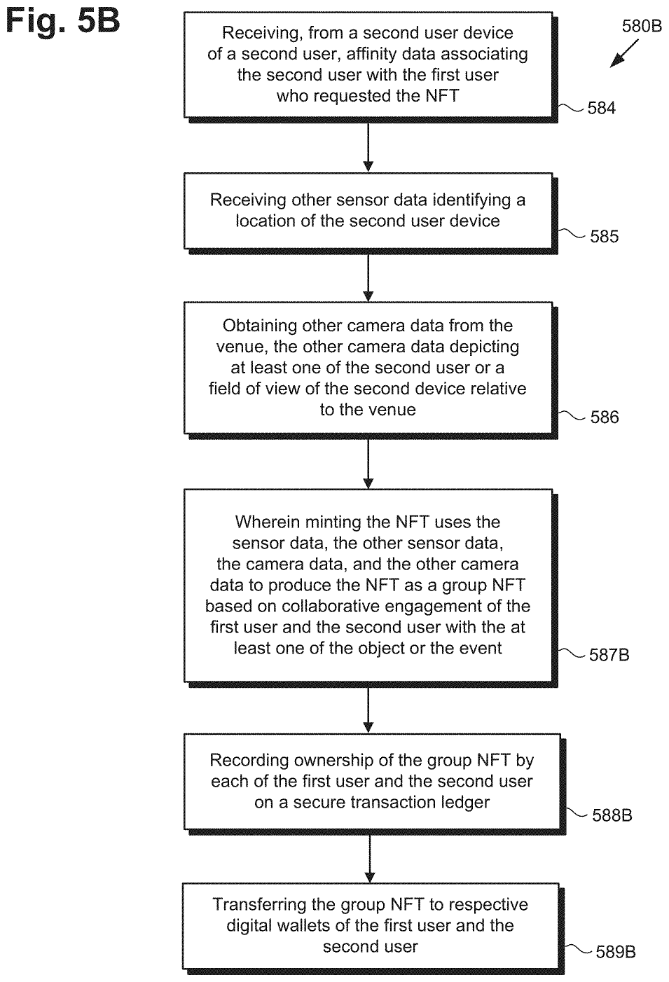

The functionality of system 110/210 will be further described below with reference to FIGS. 5A and 5B. FIG. 5A shows flowchart 580A presenting an exemplary method for providing location-specific NFTs, according to one implementation, while FIG. 5B shows flowchart 580B presenting additional actions for extending the method described in FIG. 5A. With respect to the method outlined by FIGS. 5A and 5B, it is noted that certain details and features have been left out of flowcharts 580A and 580B in order not to obscure the discussion of the inventive features in the present application.

Referring to FIG. 5A with further reference to FIG. 1, flowchart 580A includes receiving, from one of user devices 140a, 140b, 140c, or 140d (hereinafter “user device 140a” will be used in the example) request 121 for location-specific NFT 124 based on the presence of a user of user device 140a in (hereinafter “NFT collector 108a” will be used in the example) in a venue (hereinafter “venue 120a” will be used in the example) (action 581). As noted above, venue 120a may be a real-world physical venue, or a virtual venue, such as a virtual venue of an interactive video environment providing one or more of a VR, AR, or MR experience to a user. Request 121 for location-specific NFT 124 may be received, in action 581, by software code 118, executed by hardware processor 114 of system 110.

Continuing to refer to FIGS. 1 and 5A in combination, flowchart 580A further includes receiving first sensor data 122a identifying a location of user device 140a from which the request for location-specific NFT 124 was received in action 581 (action 582). As noted above, first sensor data 122a may include the latitude, longitude, attitude or any combination thereof at which user device 140a is located, or any other suitable geolocation or spatial sensor GPS data or data in the form of one or more of Near-Field Communication (NFC) data, Beacon data, Bluetooth or Bluetooth LE data, or RFID data. In some implementations, as shown in FIG. 1, first sensor data 122a may be received from user device 140a. Moreover, in some use cases first sensor data 122a may be provided by user device 140a when user device 140a is utilized by NFT collector 108a to voluntarily check in with system 110.

Alternatively, or in addition, as noted above, in some implementations, Wi-Fi, cellular network locations, IP addresses or any combination of those features may be used to determine the location of user device 140a. As another alternative, and as further noted above, a particular location, such as a seat in a stadium or other entertainment venue, or the location of object 130, may display a barcode or QR code that may be fixed, or that may cycle every few seconds, or over any other predetermined time period. In those implementations, NFT collector 108a could use user device 140a to scan such a barcode of QR code and transmit it to system 110, thereby identifying the location of user device 140a at the time of transmission of the code.

As yet another alternative, or in addition, NFT collector 108a may utilize an authenticator application, which may be supported by user device 140a, or may be shown on a display present at a particular location. The authenticator application may provide a pin number that cycles every few seconds, or over any other predetermined time period. In those implementations, the NFT collector 108a could enter that pin number into user device 140a for transmission to system 110. First sensor data 122a identifying the location of user device 140a, such as the latitude, longitude, and altitude or user device 140a for example, may be received in action 582 by software code 118, executed by hardware processor 114 of system 110.

It is noted that although Flowchart 580A depicts action 582 as following action 581, that representation is merely exemplary. In other implementations, actions 581 and 582 may be performed contemporaneously. For example, in some implementations, first sensor data 122a may be included with request 121. In yet other implementations, action 582 may precede action 581.

Referring to FIG. 3 in combination with FIGS. 1 and 5A, flowchart 580A further includes obtaining first camera data 134a from venue 120a/320, first camera data 134a depicting at least one of NFT collector 108a or a field of view of NFT collector 108a relative to venue 120a/320 (action 583). First camera data 134a may be obtained from any or all of camera(s) 132/332a-332c, and may include telemetry data for camera(s) 132/332a-332c. Such telemetry data may include one or more of the location, focal length, and zoom factor of each of camera(s) 132/332a-332c, their respective spatial orientations, in terms of polar and azimuthal angles, for example, and any other location-specific data or metadata generated by camera(s) 132/332a-332c. First camera data 134a depicting at least one of NFT collector 108a or a field of view of NFT collector 108a relative to venue 120a/320 may be obtained from venue 120a/320 by software code 118, executed by hardware processor 114 of system 110.

Referring to FIGS. 1 and 4 in combination with FIG. 5A, flowchart 580A further includes minting location-specific NFT 124, using first sensor data 122a and the first camera. data 134a, wherein location-specific NFT 124 depicts at least one of a portion of object 130/430 situated within venue 120a, or an event occurring at venue 120a (action 587A). As noted above, location-specific NFT 124 may confer ownership of a portion of object 130/430, such as a specific volume or surface area of object 130/430, rather than the entirety of object 130/430. As further noted above, in some use cases, different portions of object 130/430 may be more or less desirable to location-specific NFT collectors. Accordingly, in implementations in which the location-specific NFT minted in action 587A is a portion of object 130/430, that portion of object 130/430 may be determined by system 110 based on one or more of a loyalty status of NFT collector 108a or ownership by NFT collector 108a of one or more other NFTs.

In some implementations in which location-specific NFT 124 depicts all of object 130/430 situated within venue 120a, location-specific NFT 124 may depict NFT collector 103a as engaged in one of observing object 130/430 or interacting with the object 130/430.

In some implementations in which location-specific NFT 124 depicts all of object 130/430 situated within venue 120a, location-specific NFT 124 may depict NFT collector 108a as engaged in one of observing object 130/430 or interacting with the object 130/430.

Alternatively, where location-specific NFT 124 depicts an event in the form of a scoring play during a sporting match at venue 120a, location-specific NFT 124 may depict NFT collector 108a executing the scoring play. Alternatively, where location-specific NFT 124 depicts an event in the form of an entertainment at venue 120a, location--specific NFT 124 may depict the NFT collector 108a participating in the entertainment in one of a lead role or a supporting role. Minting of location-specific NFT in, action 587A, may be performed by software code 118, executed by hardware processor 114 of system 110.

Referring to FIGS. 1, 2, and 5A in combination, flowchart 580A further includes recording ownership of location-specific NFT 124/224 by NFT collector 108a/208 on secure transaction ledger 106/206 (action 588A), As noted above, secure transaction ledger 106/206 may take the form of a Blockchain, Hashgraph, DAG, or Holochain ledgers, to name a few examples. As further noted above, in use cases in which secure transaction ledger 106/206 is a blockchain ledger, it may be advantageous or desirable to implement secure transaction ledger 106/206 to utilize a consensus mechanism having PoS protocol, rather than the more energy intensive PoW protocol. Although secure transaction ledger 106/206 is shown to be remote from system 110/210 in FIGS. 1 and 2, such as a cloud-based or distributed secure transaction ledger, that implementation is merely exemplary. In other implementations, secure transaction ledger 106/206 may be stored in system memory 116 and may be controlled by system 110/210. Action 588A may be performed by software code 118, executed by hardware processor 114 of system 110/210, and using communication network 102/202 and network communication links 104/204.

Continuing to refer to FIGS. 1, 2, and 5A in combination, flowchart 580A further includes transferring location-specific NFT 124/224 to digital wallet 250 of NFT collector 108a/208 (action 589A). As noted above, in some implementation, digital wallet 250 can store location-specific NFT 124/224 on user device 140a/240. However, in other implementations, digital wallet 250 may not be resident on user device 140a/240, but may be a virtual wallet remote from user device 140a/240 such as a cloud-based virtual wallet accessible to user device 140a/240 via communication network 102/202 and network communication links 104/204. In yet other implementations, digital wallet 250 may be a hardware cryptocurrency wallet, such as a Ledger Nano S® device or the like. Action 589A may be performed by software code 118, executed by hardware processor 114 of system 110/210, and using communication network 102/202 and network communication links 104/204.

Although flowchart 580A depicts action 589A as following action 588A, that representation is merely exemplary. In various other implementations, action 589A may precede action 588A, or may be performed in parallel with, i.e., contemporaneously with, action 588A.

FIG. 5B, flowchart 580B describes additional actions for extending the method outlined by flowchart 580A to use cases in which multiple NFT collectors act collaboratively to enjoy an experience. Referring to FIGS. 1 and 5B in combination, flowchart 580B includes receiving, from a second user device (hereinafter “user device 140b” will be used in this example) of a second user (hereinafter “NFT collector 108b” will be used in this example), affinity data 123 associating NFT collector 108b with NFT collector 108a (action 584). As noted above, affinity data 123 may include any data enabling a particular user, such as NFT collector 108b for example, to associate himself/herself with another user, such as NFT collector 108a. Examples of affinity data 123 received from NFT collector 108b and associating NFT collector 108b with NFT collector 108a may include a phone number, email address, or a social media identifier such as a social media username of NFT collector 108a, to name a few. Affinity data 123 may be received in action 584 by software code 118, executed by hardware processor 114 of system 110/210, via communication network 102/202 and network communication links 104/204.

Continuing to refer to FIGS. 1 and 5B in combination, flowchart 580B further includes receiving second sensor data 122b identifying a location of user device 140b (action 585). Action 585 may performed by software code 118, executed by hardware processor 114 of system 110/210 in a manner analogous to that described above by reference to action 582. Although Flowchart 580B depicts action 585 as following action 584, that representation is merely exemplary. In other implementations, actions 584 and 585 may be performed contemporaneously. For example, in some implementations, second sensor data 122b may be included with affinity data 123.

Referring to FIGS. 1, 3, and 5B in combination, flowchart 580B further includes obtaining second camera data 134b from venue 120a/320, second camera data 134b depicting at least one of NFT collector 108b or a field of view of NFT collector 108b relative to venue 120a/320 (action 586). Action 586 may performed by software code 118, executed by hardware processor 114 of system 110/210 in a manner analogous to that described above by reference to action 583.

It is noted that in implementations in which the method described by FIGS. 5A and 5B include actions 584, 585, and 586, the minting of location-specific NFT 124 uses first sensor data 122a, second sensor data 122b, first camera data 134a, and second camera data. 134b to produce location-specific NFT 124 as a group NFT based on collaborative engagement by NFT collector 108a and NFT collector 108b with the object 130 or the event occurring at venue 120a (action 587B). By way of example, the different locations and perspectives represented by first sensor data 122a, second sensor data 122b, first camera data 134a, and second camera data 134b may be reconciled for the purpose of minting NFT 124 as a group NFT using on demand cloud-based computing resources, such as those provided by Amazon Web Services®, for example, in a manner analogous to that used by the National Football League@ to produce Next Gen Stats®.

With respect to the expression “collaborative engagement,” it is noted that two or more users may be collaboratively engaged with an object by contemporaneously being present within a predetermined distance of the object and by interacting with the object, at least by observing the object. Alternatively, two or more users may be collaboratively engaged with an object by being present, within a predetermined distance of the same object at different times, such as on different dates, and by interacting with the object, at least by observing the object. Two or more users may be collaboratively engaged with an event by being contemporaneously present at the event as spectators or participants. Alternatively, two or more users may be collaboratively engaged with an event when at least one user is present at the event as a spectator or participant, and at least one other user is a remote spectator of the event. It is noted that the term “engagement” may also refer to an interaction with an object or event is experienced, such as the time of year the engagement takes place, whether the engagement is related to a holiday or special event, and so forth. Action 587B may performed by software code 118, executed by hardware processor 114 of system 110/210.

Referring to FIGS. 1, 2, and 5B in combination, in implementations in which the method described by FIGS. 5A and 5B include actions 584, 585, and 586, flowchart 580B further includes recording ownership of location-specific NFT 124/224 by each of NFT collectors 108a/208 and 108b/208 on secure transaction ledger 106/206 (action 588B). Action 588B may performed by software code 118, executed by hardware processor 114 of system 110/210 in a manner analogous to that described above by reference to action 588A.

Continuing to refer to FIGS. 1, 2, and 5B in combination, flowchart 580B further includes transferring location-specific NFT 124/224 to respective digital wallets 250 of NFT collectors 108a/208 and 108b/208 (action 589B), Action 589B may performed by software code 118, executed by hardware processor 114 of system 110/210 in a manner analogous to that described above by reference to action 589A.

Although flowchart 580B depicts action 589B as following action 588B, that representation is merely exemplary. In various other implementations, action 589B may precede action 588B, or may be performed in parallel with, i.e., contemporaneously with, action 588B. With respect to the methods outlined by flowcharts 580A and 580B, it is noted that, in various implementations, actions 581, 582, 583, 587A, 588A, and 589A, or actions 581, 582, 583, 584, 585, 586, 587B, 588B, and 589B, may be performed in an automated process from which human control may be omitted.

It is noted that although the above description refers to an object presently situated within a venue, an event presently occurring at the venue, or both, those characterizations are merely provided by way of examples. In other implementations, a location specific NFT may be minted so as to be associated with an object anticipated to be present within the venue in the future, or to a future event. For example, where a new statue is to be unveiled within a venue at a future date, and where a user of the venue wishing to observe or participate in the unveiling is unable to attend, that user may commission a location-specific NFT to be minted depicting the user as an observer or participant in the unveiling. As another example, where a ceremonial event, such as a wedding for example, is scheduled to occur at a venue at a future date, and where an invitee to the ceremonial event is unable to attend, that user may commission a location-specific NFT to be minted depicting the user as an observer or participant in the ceremonial event.

Thus, the present application discloses systems and methods providing location-specific NFTs. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a system memory storing a software code;
the hardware processor configured to execute the software code to:
receive, from a user device, a request for a non-fungible token (NFT) based on a presence of a user of the user device in a venue;
receive sensor data identifying a location of the user device in the venue;
obtain camera data from the venue, the camera data depicting at least one of the user of the user device or a field of view of the user relative to the venue; and
mint the NFT, using the sensor data and the camera data, wherein the NFT depicts at least one of a portion of an object situated within the venue or an event occurring at the venue.

2. The system of claim 1, wherein hardware processor is further configured to execute the software code to:
record ownership of the NFT by the user on a secure transaction ledger; and
transfer the NFT to a digital wallet of the user.

3. The system of claim 1, wherein the venue comprises a virtual venue of an interactive video environment.

4. The system of claim 3, wherein the interactive video environment provides at least one of a virtual reality (VR), augmented reality (AR), or mixed reality (MR) experience to the user.

5. The system of claim 1, wherein the NFT depicts the portion of the object situated within the venue, and wherein the portion of the object is determined based on one or more of a loyalty status of the user or ownership by the user of one or more other NFTs.

6. The system of claim 1, wherein the NFT depicts the object situated within the venue, and wherein the NFT further depicts the user as engaged in one of observing the object or interacting with the object.

7. The system of claim 1, wherein the NFT depicts the event occurring at the venue, and wherein the NFT further depicts the user as engaged in one of observing the event or participating in the event.

8. The system of claim 7, wherein the event is a scoring play during a sporting match at the venue, and wherein the NFT depicts the user executing the scoring play.

9. The system of claim 1, wherein the NFT depicts the at least one of the object or the event from a perspective of the user.

10. The system of claim 1, wherein the user is a first user, and wherein before minting the NFT, the hardware processor is further configured to execute the software code to:
receive, from a second user device of a second user, affinity data associating the second user with the first user;
receive another sensor data identifying a location of the second user device; and
obtain another camera data from the venue, the another camera data depicting at least one of the second user or a field of view of the second user relative to the venue;
wherein minting the NFT uses the sensor data, the another sensor data, the camera data, and the another camera data to produce the NFT as a group NFT based on collaborative engagement by the first user and the second user with the at least one of the object or the event.

11. A method for use by a system including a hardware processor and a system memory storing a software code, the method comprising:
receiving, by the software code executed by the hardware processor, a request for a non-fungible token (NFT) based on a presence of a user of the user device in a venue;
receiving by the software code executed by the hardware processor, sensor data identifying a location of the user device;
obtaining camera data from the venue, by the software code executed by the hardware processor, the camera data depicting at least one of a user of the user device or a field of view of the user relative to the venue; and
minting the NFT, by the software code executed by the hardware processor and using the sensor data and the camera data, wherein the NFT depicts at least one of a portion of an object situated within the venue or an event occurring at the venue.

12. The method of claim 11, further comprising:
recording, by the software code executed by the hardware processor, ownership of the NFT by the user on a secure transaction ledger; and
transferring, by the software code executed by the processor, the NFT to a digital wallet of the user.

13. The method of claim 11, wherein the venue comprises a virtual venue of a interactive video environment.

14. The method of claim 13, wherein the interactive video environment provides at least one of a virtual reality (VR), augmented reality (AR), or mixed reality (MR) experience to the user.

15. The method of claim 11, wherein the NFT depicts the portion of the object situated within the venue, and wherein the portion of the object is determined based on one or more of a loyalty status of the user or ownership by the user of one or more other NFTs.

16. The method of claim 11, wherein the NFT depicts the object situated within the venue, and wherein the NFT further depicts the user as engaged in one of observing the object or interacting with the object.

17. The method of claim 11, wherein the NFT depicts the event occurring at the venue, and wherein the NFT further depicts the user as engaged in one of observing the event or participating in the event.

18. The method of claim 17, wherein the event is a scoring play during a sporting to match at the venue, and wherein the NFT depicts the user executing the scoring play.

19. The method of claim 11, wherein the NFT depicts the at least one of the object or the event from a perspective of the user.

20. The method of claim 11, wherein the user is a first user, and wherein before the NFT is minted the method further comprises:
receiving, by the software code executed by the hardware processor from a second user device, affinity data associating the second user with the first user;
receiving, by the software code executed by the hardware processor, another sensor data identifying a location of the second user device; and
obtaining, by the software code executed by the hardware processor, another camera data from the venue, the another camera data depicting at least one of the second user or a field of view of the second user relative to the venue;
wherein minting the NFT uses the sensor data, the another sensor data, the camera data, and the another camera data to produce the NFT as a group NFT based on collaborative engagement by the first user and the second user with the at least one of the object or the event.
